(19) United States
(12) Patent Application Publication
(10) Pub. No.: US 2019/0042413 A1
(43) Pub. Date: Feb. 7, 2019

(54) METHOD AND APPARATUS TO PROVIDE PREDICTABLE READ LATENCY FOR A STORAGE DEVICE

(71) Applicant: Intel Corporation, Santa Clara, CA (US)

(72) Inventors: Piotr WYSOCKI, Gdansk (PL); Slawomir PTAK, Gdansk (PL); Kapil KARKRA, Chandler, AZ (US)

(21) Appl. No.: 15/910,607

(22) Filed: Mar. 2, 2018

(51) Int. Cl. G06F 12/0804; G06F 12/10; G06F 11/10

(52) U.S. Cl. CPC G06F 12/0804; G06F 12/10; G06F 11/1076; G06F 2212/222; G06F 2212/1024; G06F 2212/608; G06F 2212/1032

(57) ABSTRACT

A host based Input/Output (I/O) scheduling system that improves read latency by reducing I/O collisions and improving I/O determinism of storage devices is provided. The host based storage region I/O scheduling system provides a predictable read latency using a combination of data redundancy, a host based scheduler and a write-back cache.

### FIELD

This disclosure relates to storage devices and in particular to providing predictable read latency for a storage device.

### BACKGROUND

Data may be stored in non-volatile memory in a Solid State Drive (SSD. The non-volatile memory may be NAND Flash memory. As the capacity of an SSD increases, the number of Input/Output (I/O) requests to the SSD also increases and it is difficult to provide a predictable read latency (also referred to as deterministic reads). One known issue is NAND Flash die collisions with concurrent read and write requests to the same NAND Flash die resulting in non-deterministic reads. For example, a request to read data from a NAND Flash memory die on a SSD may be completed quickly or may be stalled for a period of time waiting for a write, an erase or a NAND Flash management operation on the NAND Flash memory die to complete. Some applications require guaranteed deterministic reads during some time periods.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a computer system that includes storage region I/O scheduler logic and storage device write cache to provide a predictable read latency from a storage device;

FIG. 2 is a timing diagram illustrating scheduling of I/O operations for three NVMe Sets in an SSD;

FIG. 3 is a block diagram of a write operation to a Solid State Drive having three NVMe sets with a Redundant Array of Independent Disks (RAID) level 5 type data layout;

FIG. 4 is a flowgraph for a method for writing parity for the stripe to an NVMe set using a read-modify-write operation;

FIG. 5 is a block diagram of a read operation to a storage device having three NVMe sets with a Redundant Array of Independent Disks (RAID) level 5 type data layout; and

FIG. 6 is a flowgraph of a method for reading a stripe from the storage device shown in FIG. 5.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

Non-Volatile Memory Express (NVMe) standards define a register level interface for host software to communicate with a non-volatile memory subsystem (for example, a Solid State Drive (SSD)) over Peripheral Component Interconnect Express (PCIe), a high-speed serial computer expansion bus. The NVM Express standards are available at www.nvmexpress.org. The PCIe standards are available at pcisig.com.

Open Channel SSD is a SSD interface that allows fine grained control over data placement on NAND Flash Dies and drive background operations. The Open Channel SSD specification is available at lightnvm.io.

A host system may communicate with a Solid State Drive (SSD) using an NVMe over PCIe standard. Typically, data is written (striped) across many NAND Flash die in the SSD to optimize the bandwidth. However, there is currently no mechanism to direct a read request to a particular NAND Flash die in the SSD.

Future versions of the NVMe standards may include new features for host applications to improve drive I/O determinism. The new features include NVMe sets and deterministic/non-deterministic windows. The NVMe Sets feature is a method to partition non-volatile memory in the SSD into sets, which physically splits the non-volatile memory into groups of NAND Flash dies. NVMe Sets allow an application in the host computer to be aware of NAND Flash die collisions and to avoid them. Deterministic/non-deterministic windows allow the solid state drive internal operations to be stalled to avoid host and solid state drive internal I/O collisions. In an embodiment, deterministic window may be a time period in which a host performs only reads. The host can transition the NVM set from a non-deterministic state to a deterministic state explicitly using a standard NVMe command or implicitly by not issuing any writes for a time period. Alternatively, a host may monitor NVM Set's internal state using NVMe standard mechanisms to ensure that the NVM Set has reached a desired level of minimum internal activity where reads will likely not incur collisions and QoS issues.

An NVMe set can be a set of NAND Flash dies grouped into a single, contiguous Logical Block Address (LBA) space in an NVMe SSD or a single NAND Flash die, directly addressable (by Physical Block Address (PBA)) located in an Open Channel type SSD. More typically, an NVM Set is a Quality of Service (QoS) isolated region of the SSD. A write to NVMe Set A does not impact a read to NVMe Set B or NVMe Set C. The NVMe Set defines a storage domain where collisions may occur between Input/Output (I/O) operations.

In an embodiment, an intelligent host based I/O scheduling system improves read latency by reducing I/O collisions and improving I/O determinism of NVMe over PCIe and Open Channel SSDs. The host based I/O scheduling system includes data redundancy across storage regions (“NVMe Sets”) in the SSD an intelligent NVMe Set scheduler to schedule deterministic and non-deterministic states and a write-back cache to provide a predictable storage device read latency.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

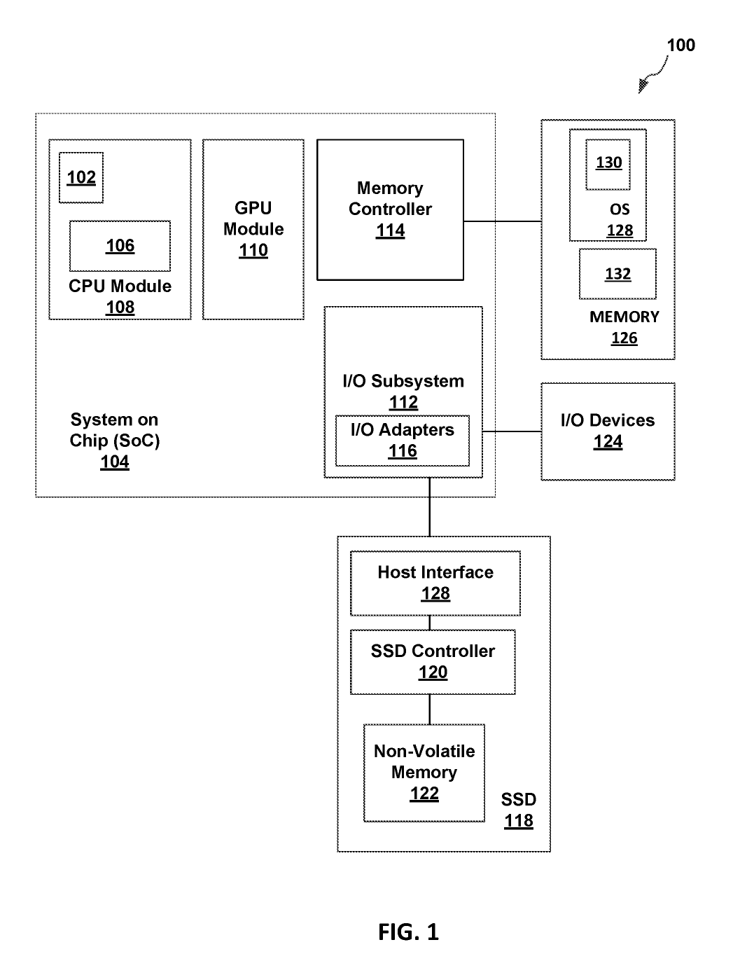

FIG. 1 is a block diagram of an embodiment of a computer system 100 that includes storage region I/O scheduler 130 and storage region write-back cache 132 to provide a predictable read latency. Computer system 100 may correspond to a computing device including, but not limited to, a server, a workstation computer, a desktop computer, a laptop computer, and/or a tablet computer.

The computer system 100 includes a system on chip (SOC or SoC) 104 which combines processor, graphics, memory, and Input/Output (I/O) control logic into one SoC package. The SOC 104 includes at least one Central Processing Unit (CPU) module 108, a memory controller 114, and a Graphics Processor Unit (GPU) 110. Although not shown, each processor core 102 may internally include one or more instruction/data caches, execution units, prefetch buffers, instruction queues, branch address calculation units, instruction decoders, floating point units, retirement units, etc. The CPU module 108 may correspond to a single core or a multi-core general purpose processor, such as those provided by Intel® Corporation, according to one embodiment.

The Graphics Processor Unit (GPU) 110 may include one or more GPU cores and a GPU cache which may store graphics related data for the GPU core. The GPU core may internally include one or more execution units and one or more instruction and data caches. Additionally, the Graphics Processor Unit (GPU) 110 may contain other graphics logic units that are not shown in FIG. 1, such as one or more vertex processing units, rasterization units, media processing units, and codecs.

Within the I/O subsystem 112, one or more I/O adapter(s) 116 are present to translate a host communication protocol utilized within the processor core(s) 102 to a protocol compatible with particular I/O devices. Some of the protocols that adapters may be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 116 may communicate with external I/O devices 124 which may include, for example, user interface device(s) including a display, a touch-screen display, printer, keypad, keyboard, communication logic, wired and/or wireless, storage device(s) including hard disk drives (“HDD”), removable storage media, Digital Video Disk (DVD) drive, Compact Disk (CD) drive, Redundant Array of Independent Disks (RAID), tape drive or other storage device. Additionally, there may be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols. The I/O adapter(s) may also communicate with a solid-state drive (“SSD”) 118 which includes a solid state drive controller 120, a host interface 128 and non-volatile memory 122 that includes one or more non-volatile memory devices.

A non-volatile memory (NVM) device is a memory whose state is determinate even if power is interrupted to the device. In one embodiment, the NVM device can comprise a block addressable mode memory device, such as NAND or NOR technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also include a byte-addressable write-in-place three dimensional crosspoint memory device, or other byte addressable write-in-place NVM devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

An operating system (OS) 128 that includes the storage region I/O scheduler 130 is stored in external memory 126. A portion of the external memory 126 is reserved for the storage region write-back cache 132. The external memory 126 may be a volatile memory or a non-volatile memory or a combination of volatile memory and non-volatile memory.

Volatile memory is memory whose state (and therefore the data stored in it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

The storage region write-back cache 132 stores data to be written to non-volatile memory 122 in the SSD 118. In addition to storing data to be written to the SSD 119, data stored in the storage region write-back cache 132 can be provided to an application executing in the host. All data to be written to non-volatile memory 122 in the SSD 118 is first written to the storage region write-back cache 132 by the operating system 128.

In the embodiment shown, the storage region write-back cache 132 is a portion of external memory 126 which may be byte addressable volatile memory or byte addressable write-in-place non-volatile memory or a combination. In other embodiments, the storage region write-back cache 132 may be a SSD that includes byte addressable write-in-place non-volatile memory and a NVMe over PCIe interface.

An operating system 128 is software that manages computer hardware and software including memory allocation and access to I/O devices. Examples of operating systems include Microsoft® Windows®, Linux®, iOS® and Android®. In an embodiment for the Microsoft® Windows® operating system, the storage region 110 scheduler 130 may be included in a port/miniport driver of the device stack. In an embodiment for the Linux® operating system, the storage region scheduler 130 may be in a storage stack (a collection of hardware and software modules) above an NVMe driver.

An NVMe set is a Quality of Service (QoS) isolated region of a storage device which may be referred to as a “storage region” of the storage device. In a storage device that is configured as multiple NVMe sets, a write to one of the plurality of NVMe sets does not impact a read to any of the other NVMe sets in the storage device. In an embodiment for a NVMe SSD that includes NAND Flash dies, an NVMe set may be a set of NAND Flash dies grouped into a single, contiguous Logical Block Address (LBA) space. In an embodiment for an Open Channel SSD that includes NAND Flash dies, an NVMe Set may be a single NAND Flash Die that is directly addressable (by a Physical Block Address (PBA)).

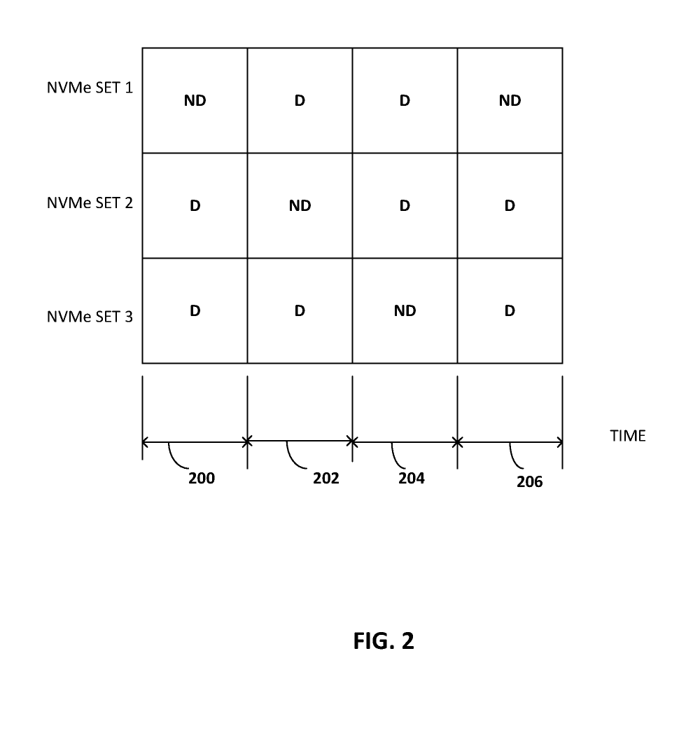

FIG. 2 is a timing diagram illustrating scheduling of 110 operations for three NVMe Sets in a SSD 118. To provide a predictable read latency for the SSD 118, two windows of time (deterministic (D) and non-deterministic (ND) state) are defined for scheduling I/O operations for NVMe sets in the SSD 118. An NVMe Set in the SSD 118 can be switched between the two states by the storage region I/O scheduler 130. The deterministic/non-deterministic state refers to both the internal state of the SSD 118 and the state of the NVMe Set for an NVMe SSD. The deterministic/non-deterministic state also applies to the state of a NAND Flash die for an Open Channel SSD. In some embodiments, the NVM Sets can be located across multiple SSDs while in others, the host 10 scheduler can transition entire SSDs to D and ND states.

The state of an NVMe Set changes over time. As shown in FIG. 2, in each timeslot 200, 202, 204, 206, only one of the three NVMe Sets in SSD 118 is in a non-deterministic (ND) state and the other NVMe Sets are in a deterministic (D) state. The timeslot may be dependent on the time required by firmware in the SSD 118 to perform background operations during the non-deterministic window. In an embodiment, each timeslot 200, 202, 204, 206 may be 500 milliseconds.

When an NVMe set is in the non-deterministic state, both read operations and write operations are allowed. For a write operation, data stored in the storage region write-back cache 132 when the NVMe set was in the deterministic state can be flushed from the write cache to the NVMe and data not already stored in the storage region write-back cache 132 can be written to both the storage region write-back cache 132 and the NVMe set. In addition, the NVMe set may perform background operations and receive a trim command indicating which blocks of data stored in the NVMe set are no longer in use so that the NVMe set can erase and reuse them. While the NVMe set is in the non-deterministic state, there is no latency guarantee for read operations sent to the NVMe set.

When the NVMe set is in the deterministic state, read latency is reduced because the storage region I/O operation scheduler 130 only allows read commands to be sent to the NVMe set in the deterministic state. The storage region I/O operation scheduler 130 does not send write requests to the NVMe set. In addition, to achieve more strict determinism, the NVMe set may not perform any internal background operations when in the deterministic state.

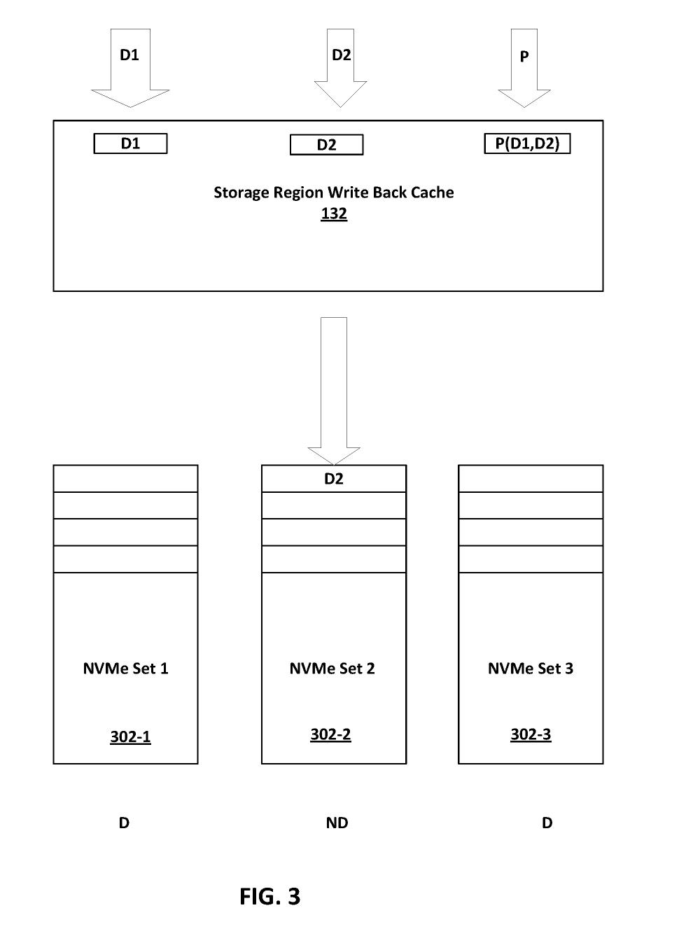

FIG. 3 is a block diagram of a write operation to a SSD 118 having three NVMe sets with a Redundant Array of Independent Disks (RAID) level 5 type data layout.

A Redundant Array of Independent Disks combines a plurality of physical storage devices into a logical drive for purposes of reliability, capacity, or performance. Instead of multiple physical storage devices, an operating system sees the single logical drive. As is well known to those skilled in the art, there are many standard methods referred to as RAID levels for distributing data across the physical storage devices in a RAID system.

A level 5 RAID system provides a high level of redundancy by striping both data and parity information across at least three storage devices. Data striping is combined. with distributed parity to provide a recovery path in case of failure. In RAID technology, strips of a storage device can be used to store data. A strip is a range of logical block addresses (LBAs) written to a single storage device in a parity RAID system. A RAID controller may divide incoming host writes into strips of writes across member storage devices in a RAID volume. A stripe is a. set of conesponding strips on each member storage device in the RAID volume. In an N-drive RAID 5 system, for example, each stripe contains N−1 data strips and one parity strip. A parity strip may be the exclusive OR (XOR) of the data in the data strips in the stripe. The storage device that stores the parity for the stripe may be rotated per-stripe across the member storage devices. Parity may be used to restore data on a storage device of the RAID system should the storage device fail, become corrupted or lose power. Different algorithms may be used that, during a write operation to a. stripe, calculate partial parity that is an intermediate value for determining parity.

The RAID levels discussed above for use with physical disk drives may be applied to a plurality of NVMe sets in SSD 118 to distribute data and parity amongst the NVMe sets to provide redundancy in the SSD 118.

The storage region write-back cache 132 acts like a write buffer. All of the data to be written to the NVMe sets in the SSD 118 is automatically written to the storage region write-back cache 132. Data to be written to a stripe is stored in the storage region write-back cache 132 until the parity for the stripe has been written to the parity NVM set 300_3 for the stripe. Until the entire stripe including parity has been written to the SSD 118, the stripe (data) is stored in the storage region write-back cache 132 so that it can be read with a predictable latency from the cache. After the entire stripe including parity for the stripe has been written to all of the NVMe sets for the stripe in the SSD, the stripe can be evicted from the storage region write-back cache 132.

As discussed earlier in conjunction with FIG. 2, write operations can only be issued to an NVMe set when the NVMe set is in the non-deterministic state. Read requests to generate parity data to be stored in an NVMe set may also be issued when the NVMe set is in the non-deterministic state. If a write to a NVMe set is sent when the NVMe set is in the deterministic state, the data to be written to the NVMe set is stored in the storage region write-back cache 132. Also, for each RAID level 5 type write operation to a stripe, parity is computed and stored in the storage region write-back cache 132 to be written to a parity NVMe set 300_3 (the NVMe set in the stripe selected for storing parity for the stripe) for a given stripe, when the parity NVMe set is in the non-deterministic state.

As shown in FIG. 3, NVMe Set 1 300_1 and NVMe Set 300_3 are in the deterministic state and NVMe Set 2 300_2 is in the non-deterministic state. Data D1, D2 and parity for data D1 and D2 P(D1, D2) are stored in the storage region write-back cache 132. Only Data 2 is written during the non-deterministic state to NVMe Set 2 300_2. A copy of the stripe (D1, D2, P(D1, D2)) is stored in storage region write-back cache 132 until the entire stripe (D1, D2, P(D1, D2)) is written to the NVMe Sets to provide a predictable read latency for the stripe.

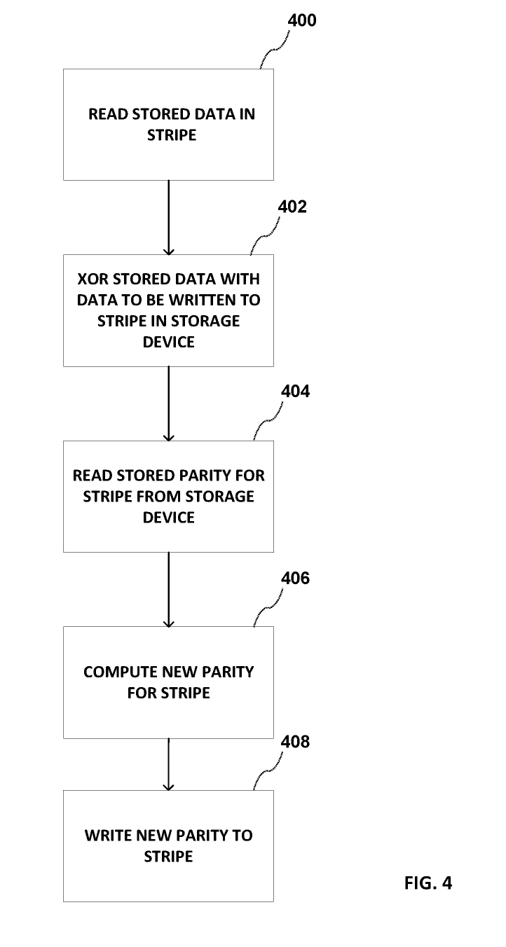

FIG. 4 is a flowgraph for a method for writing parity for the stripe to an NVMe set using a read-modify-write operation.

At block 400, data stored in the stripe from one of the NVMe Set(s) in the non-deterministic state that stores data for the stripe is read. Processing continues with block 402.

At block 402, an Exclusive OR (“XOR”) operation is performed on the data read from the stripe (“old data”) and the data to be written to the stripe (“new data”), the result of the XOR operation (“cached parity”) is stored in the storage region write-back cache 132. Processing continues with block 404.

At block 404, when the NVMe set storing parity for the stripe is in the non-deterministic state, the parity for the stripe (“old parity”) is read. Processing continues with block 406.

At block 406, an XOR operation is performed on the “old parity” and the “cached parity”. The result of the XOR operation is “new parity. Processing continues with block 408.

At block 408, while the NVMe set 300_3 storing parity for the stripe is in the non-deterministic state, the “new parity” is written to the NVMe set in the stripe storing parity for the stripe.

Blocks 404, 406 and 408 are performed while the NVMe set is in non-deterministic state. There is no guarantee that all of the operations will take place in the same deterministic/non-deterministic cycle as there may be a switch between non-deterministic/deterministic state for the NVMe set.

The size of the storage region write-back cache 132 is dependent on system workload. For example, the system workload may include constant write operations, bursts of write operations or write operations with strong locality. Strong locality refers to a system workload in which a small range of LBAs, for example out of 16 Tera Bytes (TB) of total capacity of the solution, only 200 Mega Bytes (MB) is overwritten. In a system with strong locality, all the data be stored write-back cache 132 with no need for a cache larger than 200 MB for parity.

For a constant write workload, that is, a workload without write bursts, the size of the storage region write-back cache 132 may be about 10 MB. A larger storage region write-back cache size, for example, about 2 GigaBytes (GB) allows a fast accommodation of bursts of writes. If the workload has strong locality, the read and write performance may be significantly improved by the storage region write-back cache 132, because of large hit ratio in the storage region write-back cache 132. In an embodiment with a 3 NVMe Set RAID level 5 type, the available sustained write bandwidth is half of the write bandwidth of a single NVMe Set because for all the data, there is the same amount of parity to be written and there is a single NVMe Set in non-deterministic state (available for writing) at any given time.

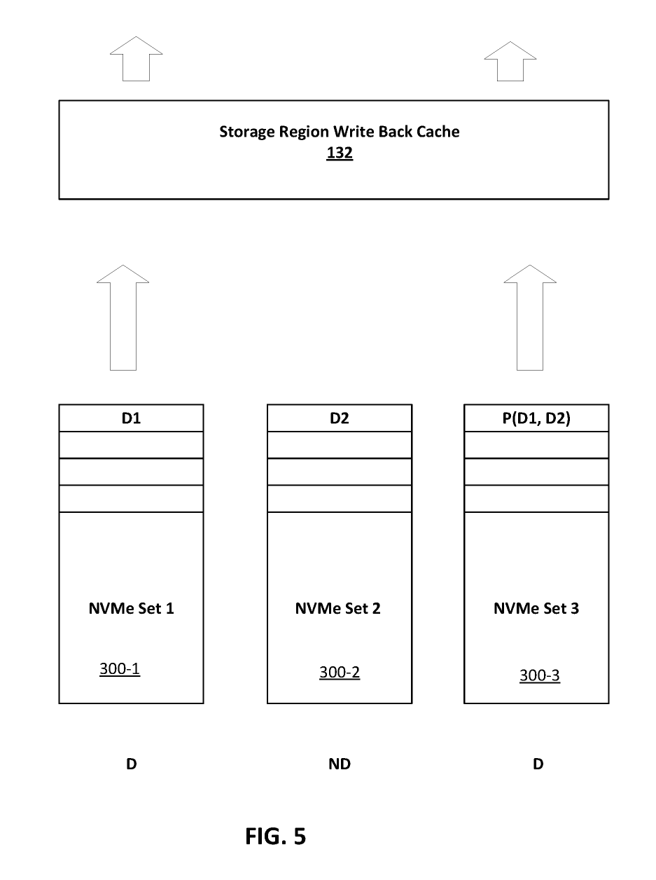

FIG. 5 is a block diagram of a read operation to a storage device having three NVMe sets with a Redundant Array of Independent Disks (RAID) level 5 type data layout. As shown in FIG. 5, a stripe includes data D1, data D2 and parity generated for D1 and D2 (P(D1, D2)). NVMe Set 1 300_1 storing D1 and NVMe Set 300_3 storing parity are in deterministic state and can be read, NVMe Set 2 storing D2 is in non-deterministic state and cannot be read at this time.

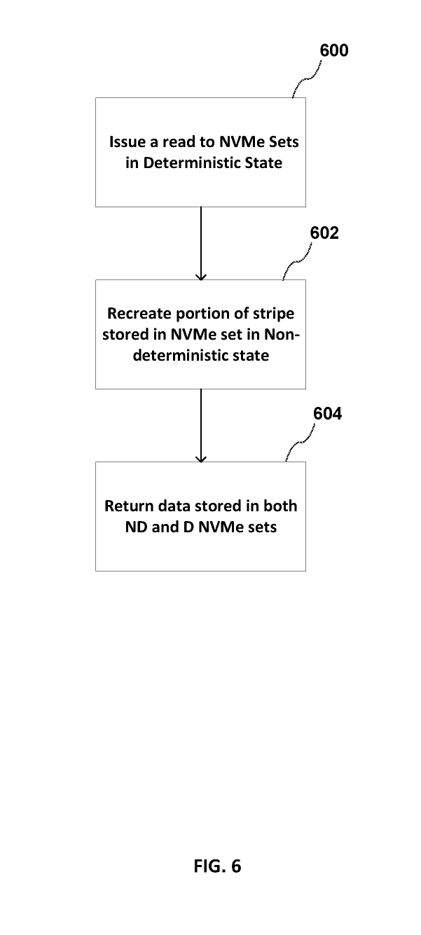

FIG. 6 is a flowgraph of a method for reading a stripe from the storage device shown in FIG. 5. FIG. 6 will be discussed in conjunction with FIG. 5.

At block 600, a read request is only issued to the NVMe sets 300-1, 300-3 that are in the deterministic state. If a read request is for data that is stored in NVMe set 300_2 that is currently in the non-deterministic state, the read request is not issued to that NVMe set 300-2, only the portion of the RAID level 5 type stripe that is in the deterministic state is read. Processing continues with block 602.

At block 602, the data D2 that is not read from the NVMe set 300-2 that is not in non-deterministic state is recreated by performing an Exclusive OR (XOR) operation on the portion of the RAID level 5 type stripe, D1, P(D1, D2) read from the NVMe sets in deterministic state.

At block 604, the read data D1 and the recreated data D2 is returned in response to the read request.

An embodiment of a predictive read latency has been described for a 3 NVMe set for a level 5 type RAID data layout. Predictive read latency can be extended to any number of SSDs or NVMe Sets. The amount of parity data can also be adjusted. For example, the predictive read may be applied to a 2 NVMe Set for level 1 RAID. A level 1 RAID system improves read performance by writing data identically to two storage devices. A read request can be serviced by any storage device in the “mirrored set”.

The predictive read latency may also be applied to an N NVMe Set for level 6 RAID. A level 6 RAID system provides an even higher level of redundancy than a level 5 RAID system by allowing recovery from double storage device failures. In a level 6 RAID system, two syndromes referred to as the P syndrome and the Q syndrome are generated for the data and stored on storage devices in the RAID system. The P syndrome is generated by simply computing parity information for the data in a stripe (data blocks (strips), P syndrome block and Q syndrome block). The generation of the Q syndrome requires Galois Field multiplications and is complex in the event of a storage device failure. The regeneration scheme to recover data and/or P and/or Q syndromes performed during storage device recovery operations requires both Galois multiplication and inverse operations.

In an embodiment, there is one redundancy group across all the NVMe Sets, for example, one RAID level 5 type volume. An embodiment with one redundancy group uses the minimum storage dedicated to data redundancy (for example, to store data parity) but more read accesses are required to recover data in case of a read directed to an NVMe Set in Non-deterministic state. In another embodiment, there may be multiple redundancy groups across all of the NVMe Sets, for example, multiple RAID level ltype or RAID level 5 type volumes. An embodiment with multiple redundancy groups requires additional storage dedicated to data redundancy but less reads are required to recover data in case of a read directed to an NVMe Set in a non-deterministic state. In addition, multiple NVMe Sets can be switched to a non-determistic state at the same time, increasing the overall write bandwidth.

An embodiment has been described for a single storage device with a plurality of NVMe Sets. In another embodiment, each NVMe Set can be a separate storage device.

In another embodiment, erasure coding can be used to generate redundant data, that may be used to reconstruct data stored in a storage device that is in the non-deterministic state when a request to read the data is received. Erasure coding transforms a message of k symbols into a longer message (code word) with n symbols such that the original message can be recovered from a subset of the n symbols. All data required to recover a full message is read from NVMe Sets that are in the deterministic state. RAID 5 and RAID 6 are special cases of erasure coding. Other examples of erasure coding include triple parity RAID and 4-parity RAID.

User data is maintained in a ‘deterministic’ state to avoid host read-write collisions and read collisions with the storage device's internal operations without any awareness regarding avoidance of collisions by an application executing in the host.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

What is claimed is:

1. An apparatus comprising:
a write-back cache to store data to be written to a storage region in a storage device; and
a storage region scheduler to provide data redundancy by writing a stripe including the data across a set of storage regions in the storage device and to provide exclusive read access to the storage region in the storage device when the storage region is in a deterministic state to return the data in the stripe with a predictable read latency.

2. The apparatus of claim 1, wherein the storage region scheduler to recreate data stored in storage regions that are in a non-deterministic state from data read from the storage region in the deterministic state.

3. The apparatus of claim 1, wherein a portion of the stripe stored in the write-back cache to be written to a storage region in non-deterministic state is read from the write back cache.

4. The apparatus of claim 1, wherein the storage region is an Non-Volatile Memory Express (NVMe) Set.

5. The apparatus of claim 4, wherein the NVMe set is a set of non-volatile memory dies grouped into a single continuous Logical Block Address addressing space.

6. The apparatus of claim 5, wherein the non-volatile memory is NAND Flash.

7. The apparatus of claim 1 wherein the storage region is a single non-volatile memory die addressable by a Physical Block Address (PBA).

8. The apparatus of claim 7, wherein the non-volatile memory is NAND Flash.

9. The apparatus of claim 8, wherein portions of a stripe read from storage regions in deterministic mode are used to recreate other portions stored in storage regions in non-deterministic mode.

10. The apparatus of claim 9, wherein the set of storage regions has at least three storage regions.

11. The apparatus of claim 9, wherein the set of storage regions has two storage regions and data stored in one of the storage regions is mirrored in the other storage region.

12. A method comprising:
storing, in a write-back cache, data to be written to a storage region in a storage device; and
providing data redundancy, by writing a Redundant Array of Independent Disks (RAID) stripe including the data across a set of storage regions in the storage device; and
providing exclusive read access to the storage region in the storage device when the storage region is in a deterministic state to return the data in the stripe with a predictable read latency.

13. The method of claim 12, further comprising:
recreating data stored in storage regions that are in a non-deterministic state from data read from the storage region in the deterministic state.

14. The method of claim 12, further comprising:
reading a portion of the stripe stored in the write-back cache to be written to a storage region in non-deterministic state from the write back cache.

15. The method of claim 12, wherein the storage region is an Non-Volatile Memory Express (NVMe) Set.

16. The method of claim 15, wherein the NVMe set is a set of non-volatile memory dies grouped into a single continuous Logical Block Address addressing space.

17. The method of claim 12 wherein the storage region is a single non-volatile memory die addressable by a Physical Block Address (PBA).

18. A system comprising:
a write-back cache communicatively coupled to the processor to store data to be written to a storage region in a storage device;
a storage region scheduler to provide data redundancy by writing a stripe including the data across a set of storage regions in the storage device and to provide exclusive read access to the storage region in the storage device when the storage region is in a deterministic state to return the data in the stripe with a predictable read latency; and
a display communicatively coupled to a processor to display at least some the data stored in a storage device.

19. The system of claim 18, wherein the storage region scheduler to recreate data stored in storage regions that are in a non-deterministic state from data read from the storage region in the deterministic state.

20. The system of claim 18, wherein a portion of the stripe stored in the write-back cache to be written to a storage region in non-deterministic state is read from the write back cache.

21. The system of claim 18, wherein the storage region is a Non-Volatile Memory Express (NVMe) Set.

22. The system of claim 21, wherein the NVMe set is a set of non-volatile memory dies grouped into a single continuous Logical Block Address addressing space.

23. A computer readable storage device having stored thereon instructions that when executed by one or more processors result in operations, comprising:
storing, in a write-back cache, data to be written to a storage region in a storage device; and
providing data redundancy, by writing a stripe including the data across a set of storage regions in the storage device; and
providing exclusive read access to the storage region in the storage device when the storage region is in a deterministic state to return the data in the stripe with a predictable read latency.

24. The computer readable storage device of claim 23, further comprising:
recreating data stored in storage regions that are in a non-deterministic state from data read from the storage region in the deterministic state.

25. The computer readable storage device of claim 23, wherein the storage region is a Non-Volatile Memory Express (NVMe) Set.
